(19) United States
(12) Patent Application Publication
(10) Pub. No.: US 2008/0286414 A1
(43) Pub. Date: Nov. 20, 2008

(54) Drink Comprising a Combination of Fish Oil and Probiotics

(75) Inventors: Janne Sande Mathisen, Oslo (NO); Henrik Mathisen, Oslo (NO)

Correspondence Address: FITZPATRICK CELLA HARPER & SCINTO, 30 ROCKEFELLER PLAZA, NEW YORK, NY, 10112, US

(73) Assignee: PHARMALOGICA AS, OSLO (NO)

(21) Appl. No.: 11/993,336

(22) PCT Filed: Jun. 21, 2006
(86) PCT No.: PCT/NO2006/000238

§ 371 Date: May 30, 2008

(30) Foreign Application Priority Data
Jun. 27, 2005 (NO) 20053136

(51) Int. Cl. A23L 1/30

(52) U.S. Cl. 426/61

(57) ABSTRACT

The present invention relates to a stable and tasty drink comprising fish oil in an oil-in-water emulsion and probiotics. Said probiotic bacteria are preferably Lactobacillus acidophilus. A process for the preparation of the drink is also disclosed.

### FIELD OF INVENTION

The present invention relates to a drink containing fish oil and probiotics and the preparation thereof.

### DESCRIPTION OF PRIOR ART

Fish oil is the richest dietary source of long-chain omega-3 polyunsaturated fatty acids (PUTFA). Stabilisation of omega-3 PUFA against oxidation is an important task in food processing.

Fatty acids are the building blocks of dietary fats. The human body stores such dietary fats substantially in the form of triglycerides. Triglycerides containing omega-3 fatty acids are mainly found in fish.

The omega-3 fatty acids are essential to life at any stage, even before birth. They are essential building blocks of the membrane of every cell in the body and their presence are a necessity for maintaining an adequate cell membrane. They do also contribute in the regulation of most biological functions, including those of the cardiovascular, reproductive, immune and nervous systems.

The nutritional value of omega-3 for humans is well known and recognized by scientists and medical skilled persons all over the world. Several studies have been conducted within the field and significant benefits have been revealed on omega-3 in relation to the immune system, on supporting brain development and nervous system. Other studies support benefits of omega-3 intake when suffering from asthma or eczema. There is at present focus on the role of Omega 3 for children suffering from ADHD or other concentration problems.

The typical diet today gives a lack of omega-3. The Health authorities in Norway, Mattilsynet, are now actively advising the public to eat fish for dinner 4 times a week.

Working with marine oil preparations shows that it is extremely difficult to prevent the oxidation of fatty acids. Event thought the processing and storage are conducted in an inert atmosphere, and the product are filled on air tight dose units, it has been difficult to prevent the oxidation completely and to offer a product where the fishy taste is eliminated or fully masked and the unpleasant aftertaste is no longer present.

Many different manners are used in order to disguise the fishy taste/smell or prevent the oxidation of the fish oil, i.e. adding antioxidants etc.

Prior art the Norwegian Patent Application No 2004 4542 provides a creamy oil-in-water emulsion, wherein the oxidation of fatty acids is reduced to an acceptable level.

Probiotic bacteria are known to be beneficial to the gastrointestinal tract of mammals. Stress, diet, age, environmental factors, antibiotics, disease, premature birth, and baby formula composition can negatively alter the bacterial composition of micro flora. Research programs are now focused on restoring the intestinal flora through the use of probiotics and prebiotics. With renewed public interest in healthy foods, manufacturers have begun producing several new milk products containing the probiotics Lactobacillus and Bifidobacterium. These healthy bacterial cultures are now being incorporated into yoghurts, breakfast foods, cheese, drinks, and spreads to enhance market value of milk.

At present many fish-oil preparations are available. However no fish oil preparations are available as tasty drinks. Further, different functional food preparations containing probiotics are available.

Therefore, there is a need for a stable and tasty drink combining the benefits of fish-oil and probiotics, which will be a drink of choice both due to the health promoting effects and when thirsty.

### PRESENT INVENTION

Thus the present invention provides a new drink combining
a) fatty acids, especially omega-3 fatty acids essential for life
b) probiotics beneficial to the micro flora of the intestine, and
c) water for maintenance of water balance of the body

Through the present invention it has surprisingly been found that addition of probiotics to an oil-in-water emulsion of fish oil stabilizes the oxidation of fatty acids, revealing a more stable, tasty and user-friendly product. Thus, the present invention provides a new tasty drink containing fish oil and probiotics. Due to the fact that the present invention provides a tasty drink, it will contribute to the maintenance of the water balance and be a drink of choice to thirsty people.

The drink according to the invention is a non-milk based product. As such it is a product of choice to people suffering from milk allergies or lactose intolerance. At present no non-milk based drinks containing probiotics are available.

One object of the present invention is to provide a new palatable drink including fish oil, omega-3 fatty acids and probiotics in a preparation without any fishy taste or after taste. The term palatable is herein defined as a drink with a pleasant flavor, taste and aftertaste. The content of fish oil in said drink is from 5% to 20% in an oil-in-water emulsion.

A further object of the present invention is to provide a stable drink wherein the oxidizing processes of the fatty acids have been lowered to a minimum. The probiotic bacteria play an important role in preventing oxidation and promoting stability. Lactobacillus acidophilus produces lactic acid, hydrogen peroxide and other byproducts that make the environment hostile for undesired organisms. Lactobacillus acidophilus demonstrates antioxidative activity with inhibition rates of ascorbate autoxidation in the range of 7-12%. mechanisms including metal ion chelating ability, scavenge of reactive oxygen species, enzyme inhibition, and reducing activity of intracellular cell-free extract of lactic acid bacteria. This activity by the culture provides a source of dietary antioxidants.

A further object of the present invention is to provide a drink in daily dose units containing the recommended daily dosage of omega-3 fatty acid and probiotics.

These and further objects are achieved by the present invention.

### DETAILED DESCRIPTION OF THE INVENTION

The present invention relates to a new drink comprising fish oil and probiotics. The fish oil is emulsified using a suitable emulgator to an oil-in water emulsion. The activity of the probiotics provides a source of dietary antioxidants.

One preferred embodiment of the present invention provides a drink wherein said fish oil is present in an amount of about 5-20%, preferably 5-10%. The fish oil may be selected from any fish oil preparation of appropriate quality.

Another preferred embodiment of the present invention provides a drink wherein the probiotic bacteria are selected from the genus Lactobacillus, preferably Lactobacillus acidophilus. However, any probiotic bacteria suitable for stabilizing the oxidation of the fish oil and beneficial to the body may be used.

Another preferred embodiment of the present invention provides a drink further comprising sweetener, flavoring agents, antioxidants and preservatives. As such the drink may be given any desirable taste.

In one aspect of the invention the suitable emulgator is milk solids, preferably Grindsted FF 1125.

Another preferred embodiment of the present invention provides a drink wherein said preservative is potassium sorbate.

Another preferred embodiment of the present invention provides a drink wherein said sweetener is xylitol.

Another preferred embodiment of the present invention provides a drink wherein the drink is filled in daily dose units, preferably airtight bottles but any suitable container may be applicable.

One especially preferred embodiment of the present invention is a drink comprising

| | |
|---|---|
| Water | 86.45% |
| Fish oil | 5.00% |
| Potassium Sorbate | 0.10% |
| Xylitol | 5.00% |
| Citric acid | 0.25% |
| Grindsted FF 1125 | 3.00% |
| Guardian Rosemary Extract | 0.02% |
| Grindox Toco 50 Antioxidant | 0.01% |
| Jackfruit Flavoring | 0.15% |
| Lactobacillus acidophilus | 0.02% |
| Total | 100.00% |

The drink may be prepared by adding any suitable flavouring agent giving the desired taste.

Further, the present invention relates to a process for the preparation of a drink comprising the steps of:
a) forming an (liquid) oil-in-water emulsion comprising of 5-20% fish oil under inert atmosphere;
b) adding the probiotics either directly to the fish oil or to the water prior to emulgation, or to the formed emulsion
c) filling said drink onto suitable airtight containers.

The containers may preferably be small bottles ready to be used. Bottles containing different amounts of fatty acids and probiotics adjusted to the recommended daily dose of adults, children and infant are possible. The processing and packaging are conducted under an inert atmosphere at a temperature between 0-10° C. The product is stored at a temperature of 0-10° C.

The present invention will now be further described with reference to the following, non-limiting example.

### EMBODIMENTS

### Example 1

Preparation of a jackfruit drink

| Composition in percentages | |
|---|---|
| Water | 86.45 |
| Fish oil | 5.00 |
| Potassium Sorbate | 0.10 |
| Xylitol | 5.00 |
| Citric acid | 0.25 |
| Grindsted FF 1125 | 3.00 |
| Guardian Rosemary Extract | 0.02 |
| Grindox Toco 50 Antioxidant | 0.01 |
| Jackfruit Flavoring | 0.15 |
| Lactobacillus acidophilus | 0.02 |
| Total | 100.00 |

The drink is prepared by:
a) forming an oil-in-water emulsion comprising of 5-20% fish oil under inert atmosphere,
b) adding the probiotics either directly to the fish oil or the water prior to emulsification, or to the emulsion provided; and
c) filling the resultant drink onto suitable airtight containers.

The containers may preferably be small bottles ready to be used. Bottles containing different amounts of fatty acids and probiotics adjusted to the recommended daily dose of adults, children and infant are possible. The processing and packaging are conducted under an inert atmosphere at a temperature between 0-10° C. The product is stored at a temperature of 0-10° C.

The fish oil is provided by Maritex AS, Norway, product no 43-10. All other ingredients are commercially available by Danisco A/S, Langebrogade 1, DK-1001 Copenhagen.

GRINDSTED FF 1125 Stabiliser System (E 1422, milk solids, E 1442, E 415)

Jackfruit Flavouring T 10729 (NI, liquid)

GRINDOX™ TOCO 50 Antioxidant (E 306, rapeseed oil)

GUARDIAN™ Rosemary Extract 201 (natural rosemary extract)

Lactobacillus acidophilus NCFM®

1. Drink comprising a combination of fish oil in an oil-in-water emulsion and probiotics.

2. Drink, according to claim 1, further comprising a suitable emulgator, sweetener, flavoring agents, antioxidants and preservatives.

3. Drink, according to claim 1 wherein the content of fish oil is about 5-20%.

4. Drink, according to claim 1, wherein said the probiotic is selected from the genus Lactobacillus.

5. Drink, according to claim 4, wherein the lactobacillus strain is Lactobacillus acidophilus

6. Drink, according to claim 2, wherein said suitable emulgator is milk solids.

7. Drink, according to claim 6, wherein said milk solids is Grindsted FF 1125.

8. Drink, according to claim 2, wherein said preservative is potassium sorbate.

9. Drink, according to claim 2, wherein said sweetener is xylitol.

10. Drink according to claim 1, wherein the drink is filled in daily dose units, preferably in airtight bottles.

11. Drink according to claim 1, comprising

| | % |
|---|---|
| Water | 86.45% |
| Fish oil | 5.00% |
| Potassium Sorbate | 0.10% |
| Xylitol | 5.00% |
| Citric acid | 0.25% |
| Grindsted FF 1125 | 3.00% |
| Guardian Rosemary Extract | 0.02% |
| Grindox Toco 50 Antioxidant | 0.01% |
| Jackfruit Flavoring | 0.15% |
| Lactobacillus acidophilus | 0.02% |
| Total | 100.00% |

12. A process for the preparation of a drink comprising;
a) forming an (liquid) oil-in-water emulsion comprising of 5-20% fish oil under inert atmosphere;
b) adding the probiotics either directly to the fish oil or the water prior to emulsification, or to formed emulsion
c) filling said drink onto suitable airtight containers.

13. A sealed container containing a drink as claimed in claim 1.
